(19) United States
(12) Patent Application Publication
(10) Pub. No.: US 2004/0149633 A1
(43) Pub. Date: Aug. 5, 2004

(54) Screen for screening of pulp suspensions

(76) Inventor: Borje Fredriksson, Grastorp (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/478,575

(22) PCT Filed: May 30, 2002
(86) PCT No.: PCT/SE02/01015

(30) Foreign Application Priority Data
May 30, 2001 (SE) 0101895-1

(51) Int. Cl. B07B 1/49

(52) U.S. Cl. 209/411; 209/406

(57) ABSTRACT

A tubular screen for screening of pulp suspensions comprises a mantle wall (1), which is provided with screen passages, and external support rings (6), which reinforce the mantle wall so that the latter is resistant to and is not deformed by dynamic forces during operation. Each support ring is designed with a conical surface (7), which abuts and presses directly or indirectly against the mantle wall (1).

The present invention relates to a tubular screen for screening of pulp suspensions, comprising a mantle wall provided with screen passages, and at least one support ring surrounding the mantle wall and arranged to reinforce the mantle wall so that the latter is resistant to and is not deformed by dynamic forces during operation.

Such a tubular screen is used in screen devices having a pulse-generating rotor arranged within the screen. When the rotor rotates in the pulp suspension it generates pressure and suction pulses that give rise to strong dynamic forces on the inside of the screen. Such dynamic forces are detrimental to the screen since they fatigue the material of the screen, which has proved to result in a relatively short lifetime for screens of this kind. Besides, the detrimental dynamic forces increases with increasing concentration of pulp in the pulp suspension that is screened.

EP 0705936 A1 shows a known screen of this kind, in which the mantle wall comprises rod elements, which are distributed in the circumference of the screen spaced apart from one another so that slot shaped screen passages are formed between adjacent rod elements. Concentric fixing rings surround the rod elements from the external side of the screen and fix the rod elements relative to one another. Support rings extend along and press against respective fixing rings, so that the fixing rings are subjected to a radially inwardly directed force.

With the intension to increase the lifetime of the known screen the support rings are shrunk on the fixing rings. The shrinkage fit created in each pair of support ring and fixing ring gives the known screen a better fatigue resistance than that given by a prior construction of this kind of screen in which support rings were welded on the fixing rings. However, when fabricating the known screen it is troublesome to shrink the support rings on respective fixing rings so that a desired shrinkage force is obtained at each support ring. Since the support rings are shrunk in place one at a time the shrinkage operation for a new support ring negatively affects the shrinkage force on an adjacent support ring that already has been shrunk. This is due to the fact that when a support ring is shrunk on a fixing ring the tubular screen is somewhat contracted at the area of the support ring, which results in that an adjacent support ring that already has been shrunk assumes a reduced shrinkage force and sometimes even is completely loosened from its fixing ring. Owing to this, weakened sections of the known screen can arise resulting in that the screen will not obtain the expected increased lifetime.

The object of the present invention is to provide an improved screen of the above-described known kind, which has a reliable strength and as a result an expected long lifetime.

This object is obtained by a tubular screen of the kind stated initially characterized in that the support ring is designed with a conical surface abutting and pressing directly or indirectly against the mantle wall.

According to a first particularly simple embodiment of the invention, the mantle wall is conical with the same cone angle as that of the conical surface of the support ring. In this case bending a thin plate with predrilled holes that constitute the screen passages may form the mantle wall.

According to a second embodiment of the invention the mantle wall forms an angular bulge, wherein the conical surface of the support ring presses against the bulge. The bulge preferably is designed with a conical surface complementary with a conical surface of the support ring. In this case the mantle wall may consist of a cylindrical thin plate with drilled screen passages. The screen may be oriented vertically with the conical surface of the support ring resting directly or indirectly on the angular bulge, so that the weight of the support ring is utilized in order to reinforce the mantle wall.

The screen according to the second embodiment suitably includes several conical support rings pressing against respective annular bulges formed by the mantle wall. To enable a simple assemblage of the support rings on their bulges the support rings may be designed with different inner diameters and the bulges be designed with different outer diameters. The differently sized bulges are arranged in the order of size in series after one another on the mantle wall so that the smallest bulge, which is the first bulge at one end of the screen, is bordered by a larger bulge, which in turn is bordered by yet a larger bulge and so on. The support ring that fits on the largest bulge is designed with an inner diameter that enables it to be applied on the screen and pass the remaining bulges to abut against the largest bulge. In the same manner the support ring fitting on the second largest bulge is designed with an inner diameter that enables the support ring to be applied on the screen and pass the smaller bulges to abut against the second largest bulge and so on.

According to a third embodiment of the invention, the mantle wall is composed of several separate wall segments distributed in the circumference of the screen, wherein the support ring subjects the wall segments to radially inwardly directed forces for secure fixing of the wall segments to one another. Each wall segment preferably has at least one external projection, wherein the conical surface of the support ring presses against the external projection. Suitably, each projection is formed with a conical surface complementary with the conical surface of the support ring. Like the second embodiment the screen according to the third embodiment may be oriented vertically with the conical surface of the support ring resting directly or indirectly on the projections of the wall segments.

The projections of the wall segments suitably form an annular bulge around the mantle wall, wherein the conical surface of the support ring presses against the bulge. The screen according to the third embodiment may include several conical support rings that are pressing against the respective annular bulges formed by projections of the wall segments, wherein the support rings and the bulges are designed and arranged in the same manner as described above in connection with the second embodiment.

The above described wall segments may advantageously be made of non-bendable material, for example castings. With wall segments of castings the wall segments will be stiff such that the required number of support rings is reduced. In many cases it is sufficient with three support rings.

In the screen according to the second and third embodiment, respectively, the conical surface of each support ring may press indirectly against the associated bulge via an assemblage ring, which is arranged between the support ring and the bulge, wherein the assemblage ring is designed with a radially outer conical surface, which is complementary with the conical surface of the support ring and which abuts against the latter. Each assemblage ring may be provided with a radially inner conical surface, which abuts against its bulge. The support ring is suitably divided at at least one point to enable longitudinal change when the support ring is pressed on. Each support ring may have a first axial end surface and a second axial end surface having a larger radial extension than the first end surface, and each assemblage ring may be provided with a flange that abuts against the second axial end surface at the corresponding support ring. A radially inner conical surface of each assemblage ring may have a smaller cone angle than the conical surface of each support ring. Where the screen is vertically oriented each support ring rests on its assemblage ring.

According to a fourth embodiment of the invention, the mantle wall includes rod elements, which are distributed in the circumference of the screen spaced from one another so that the screen passages are formed between adjacent rod elements.

Concentric fixing rings surround the rod elements from the external side of the screen and fix the rod elements relative to one another. In this case the conical surface of the support ring abuts and presses directly or indirectly against any of the fixing rings to provide radially inwardly directed forces on the rod elements through the fixing ring associated, to the support ring. Normally, when several fixing rings are provided with such conical support rings it is made possible that all fixing rings are subjected to equally large radial forces.

The fixing ring associated to the support ring preferably is designed with a conical surface which is complementary with the conical surface of the support ring and which abuts against the latter. Where the screen is vertically oriented the support ring rests on its associated fixing ring. Suitably, the support is divided at at least one point to enable longitudinal change when the support ring is pressed on, and to enable assemblage of support rings on fixing rings with the same diameter.

The screen according to the fourth embodiment may include a mechanical joint that axially presses the support ring against its associated fixing ring. An annular holder may be arranged abutting against the fixing ring of the support ring so that the latter is between the support ring and holder, wherein the mechanical joint engages the support ring and holder and clamps these against said two fixing rings. The holder may include an additional support ring with a conical surface abutting against the fixing ring associated to the additional support ring. The conical surfaces of the support rings may have the same or different cone angles.

Like the second and third embodiments the screen according to the fourth embodiment may be provided with an assemblage ring. In this case the conical surface of the support ring abuts indirectly against the fixing ring associated to the support ring via the assemblage ring, which is arranged between the support ring and fixing ring. Furthermore, the assemblage ring is designed with a radially outer conical surface, which is complementary with the conical surface of the support ring and which abuts against the latter.

The assemblage ring may also be designed with a radially inner conical surface, which abuts against the fixing ring and which may have a smaller cone angle than the conical surface of the support ring. In this case the support ring may be designed with two axial end surfaces, one end surface of which has a larger radial extension than the other end surface, and the assemblage ring is designed with a flange abutting against the other end surface.

Alternatively the assemblage ring may be designed with a radially inner cylindrical surface abutting against the fixing ring. For example, the cylindrical surface may form the bottom in an angular groove in the assemblage ring.

Where the screen according to the fourth embodiment is vertically oriented the support ring rests on the assemblage ring.

Where assemblage ring is used in any of the above described embodiments it is suitably slotted to enable radial expansion of the assemblage ring when assembling. Alternatively the assemblage ring may be divided in at least two separate pieces.

The invention is explained in more detail in the following with reference to the accompanying drawings, in which

FIG. 1 shows a partial view of an axial cross-section through a known screen with support rings shrunk thereon,

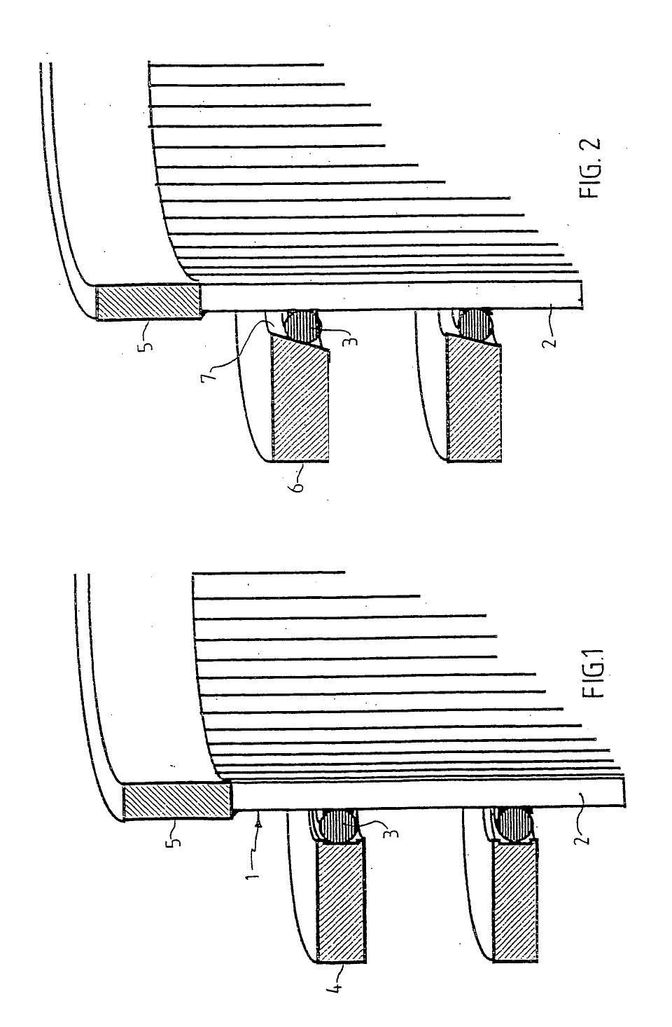

FIG. 2 shows a partial view of an axial cross-section through an embodiment of the screen according to the invention with a mantle wall including rod elements,

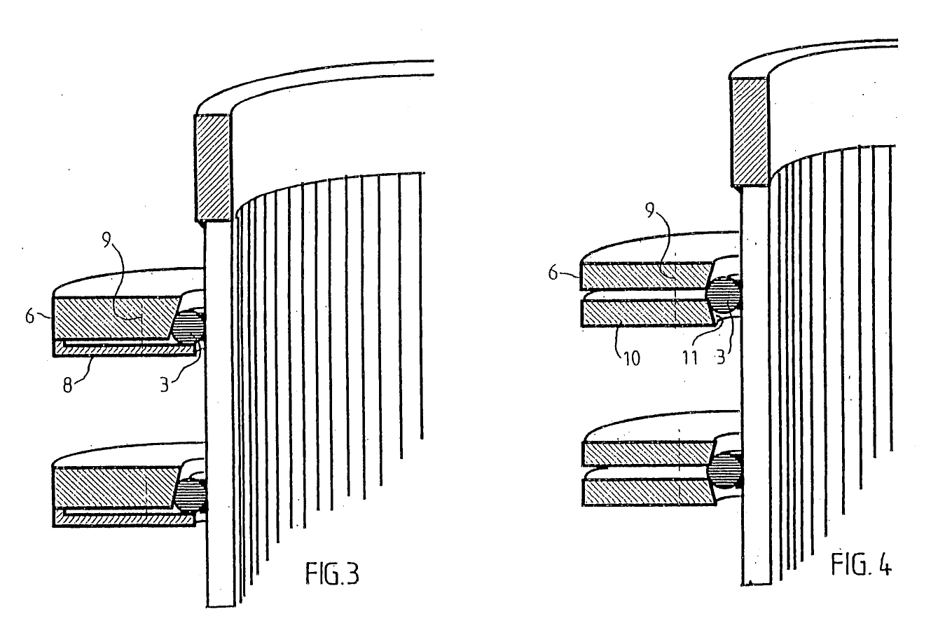

FIGS. 3-5 show three modifications of the embodiment according to FIG. 2,

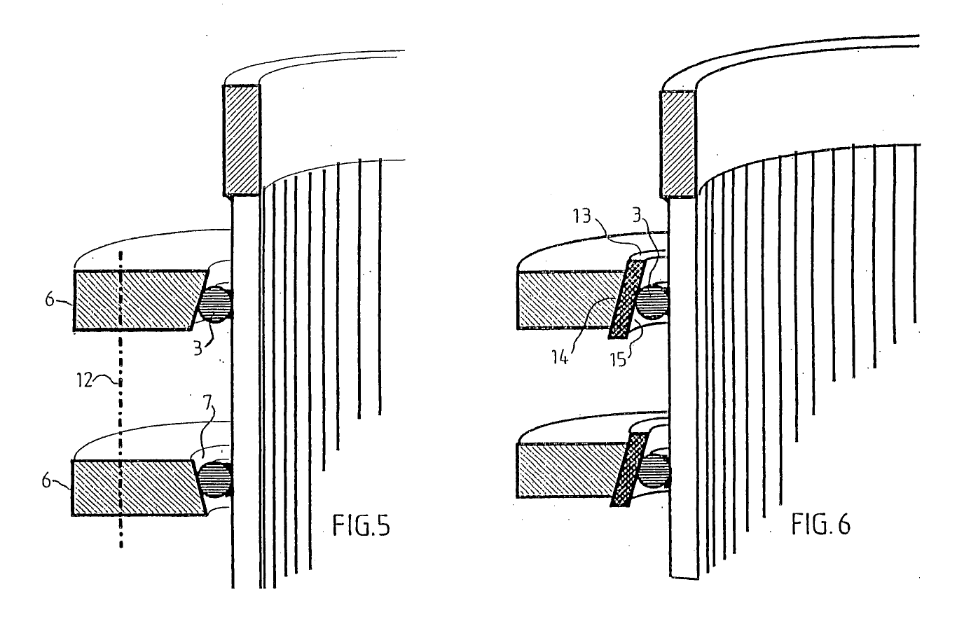

FIG. 6 shows the embodiment according to FIG. 2 provided with an assemblage ring,

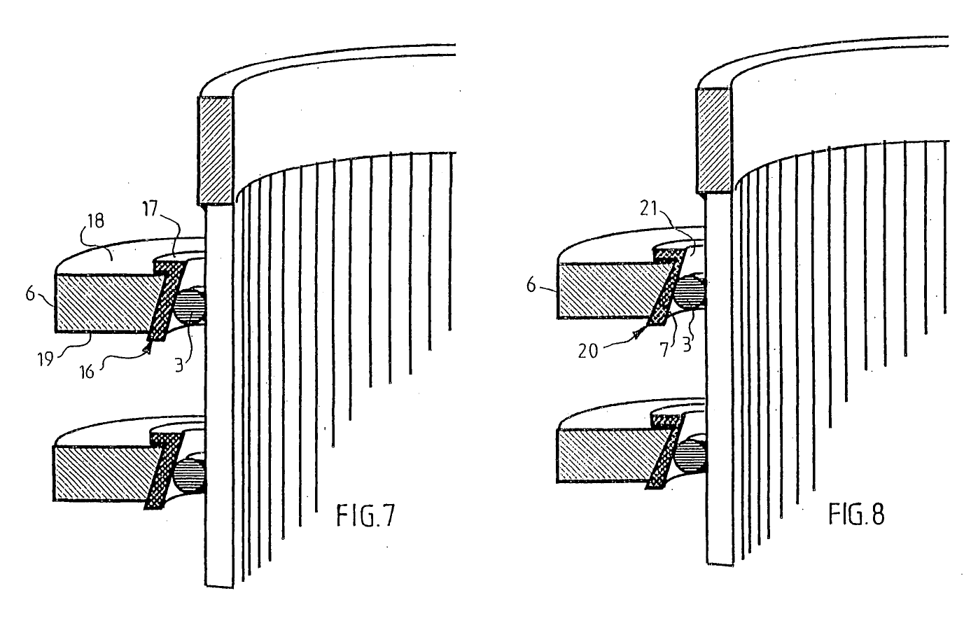

FIGS. 7-9 show three modifications of the assemblage ring in the embodiment according to FIG. 6,

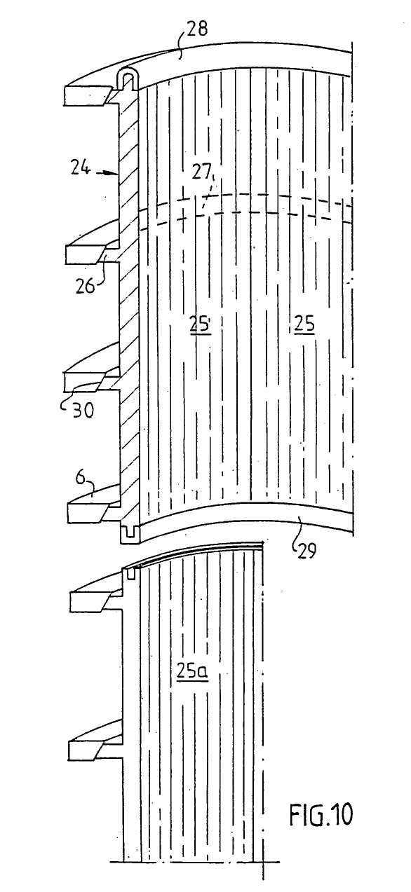

FIG. 10 shows a partial view of an axial cross-section through another embodiment of the screen according to the invention with a mantle wall including perforated wall segments, and

FIG. 11 shows a partial view of an axial cross-section through a further embodiment of the screen according to the invention with a mantle wall consisting of a bent plate.

In the figures identical elements have been provided with the same reference numerals.

FIG. 1 shows a known cylindrical screen with a mantle wall 1, which includes vertical metallic rod elements 2, distributed in the circumference of the screen at small distances from one another so that screen passages in the form of slots are formed between adjacent rod elements 2.

Concentric fixing rings 3 with circular cross-section surround the rod elements 2 from the external side of the screen and fix the rod elements 2 relative to one another in the circumferential direction of the screen. Support rings 4.with basically rectangular cross-sections surround the respective fixing rings 3 and are shrunk thereon to reinforce the mantle wall 1. Through welding the rod elements 2 are rigidly joined at their ends to an upper metal ring 5 and a lower metal ring (not shown).

FIG. 2 shows an embodiment of the screen according to the invention, which is identical to the known screen according to FIG. 1, with the exception of that each support ring 4 is replaced with a loose support ring 6 designed with a downwardly directed conical surface 7, which abuts and by the own weight of the support ring 6 presses indirectly via the fixing ring 3 against the mantle wall.

FIG. 3 shows the same embodiment as FIG. 2 supplemented with a mechanical joint that presses each support ring 6 axially against its associated fixing ring 3. The mechanical joint, includes an annular holder 8 that abuts against the fixing ring 3 so that the latter is between the support ring 6 and the holder, and fastening elements, for example in the form of screws, which join the holder 8 to the support ring 6. In FIG. 3 the fastening elements are indicated in dashed dotted lines 9.

FIG. 4 shows the same embodiment as FIG. 3, with the exception of that each holder 8 is replaced with a support ring 10 of the same kind as the support ring 6. However, the support 10 is arranged with its conical surface 11 turned upwards. In this embodiment the support rings 6 and 10 are thinner than in the preceding embodiments of the invention to make possible that the support ring 6, 10 can abut against the same fixing ring 3 without disturbing each other.

FIG. 5 shows the same embodiment as FIG. 2 supplemented with a mechanical joint, which in FIG. 5 is indicated in a dashed dotted line 12. The mechanical joint 12 joins pairs of adjacent support rings 6 to each other. The two support rings 6 of each pair are designed so that the conical surfaces are open towards each other and thereby cooperate via the mechanical joint. This embodiment is suitable for vertically mounted screens.

FIG. 6 shows the same embodiment as FIG. 2 supplemented with assemblage rings 13, which are arranged between respective support rings 6 and associated fixing rings 3. Each assemblage ring 13 is designed with a radially outer conical surface 14, which is complementary with and abuts against the conical surface 3 of the support ring 6, and a radially inner conical surface 15, which is parallel with the outer conical surface 14 and which abuts against the fixing ring 3. The assemblage rings 13 facilitate the assemblage of the support rings 6 on the respective fixing rings 3, since each support ring 6 can pass optional fixing rings 3 when axially moving along the cylindrical mantle wall 1 before the support ring 6 is mounted with the aid of an assemblage ring 13 on an intended fixing ring 3. Each assemblage ring 13 either is slotted to enable tangential/radial expansion of the assemblage ring 13 for mounting on an optional fixing ring 3 or divided into at least two separate pieces.

FIG. 7 shows the same embodiment as FIG. 6, with the exception of that each assemblage ring 13 is replaced by another assemblage ring 16, which is designed with a flange 17. In addition to this, the assemblage ring 16 is identical to the assemblage ring 13. Each support ring 6 is designed with an upper axial end surface 18 and a lower axial end surface 19, which has a smaller radial extension than the upper end surface 18. The flange 17 abuts against the upper axial end surface 19 of the support ring 6.

FIG. 8 shows the same embodiment as FIG. 7, with the exception of that each assemblage ring 16 is replaced by a modified assemblage ring 20, the inner conical surface 21 of which is smaller than the conical surface 7 of the support ring 6. In addition to this, the assemblage ring 20 is identical to the assemblage ring 16.

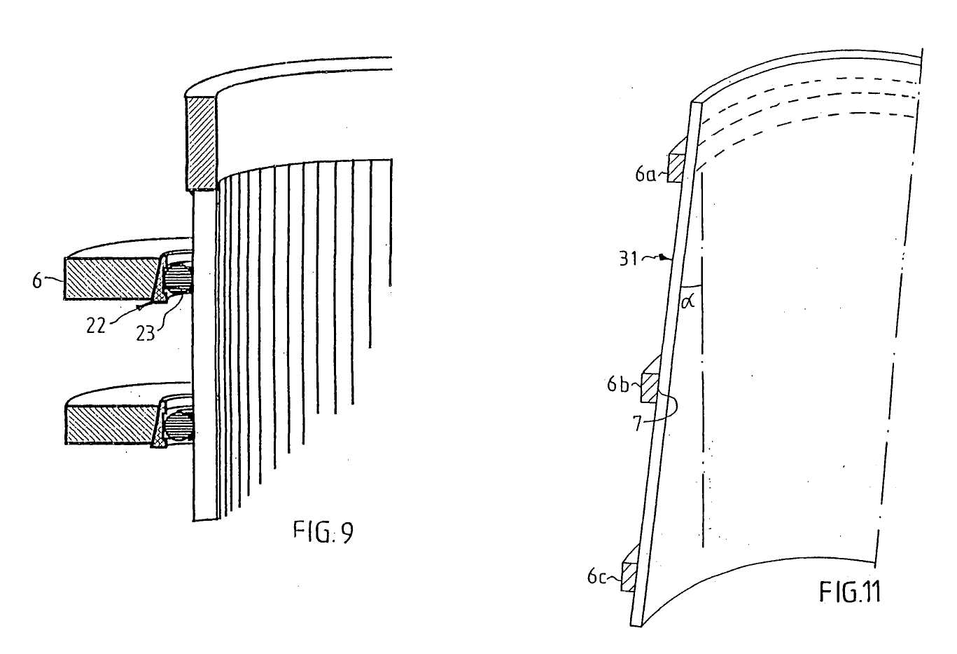

FIG. 9 shows the same embodiment as FIG. 6, with the exception of that each assemblage ring 13 is replaced by another assemblage ring 22, which is designed with a radially, inner cylindrical surface forming a bottom in an angular groove 23 in the assemblage ring 22.

FIG. 10 shows an embodiment of the screen according to the invention, which includes a basically cylindrical mantle wall 24, composed of several separate wall segments 25 distributed in the circumference of the screen. The wall segments 25 are designed with external projections 26, which form a number of annual bulges 27 around the mantle wall 24. Each bulge 27 has an external conical surface 30. As shown in FIG. 10 the axial ends of the wall segments 25 may be mounted against an upper end ring 28 and a lower end ring 29. Support rings 6 abut with their conical surfaces 7 against the conical surfaces 30 of the respective bulges 27.

As indicated in FIG. 10, additional wall segments 25a may be mounted axially on the wall segments 25 to form mantle walls 24 of different lengths.

Assemblage rings of the kind described above in connection with the embodiments according to FIGS. 6-8 may also be arranged in the embodiment according to FIG. 10.

FIG. 11 shows a simple embodiment of the screen according to the invention, which includes en conical mantle wall 31 of a thin perforated plate. Three differently sized support rings 6a, 6b and 6c abut directly against the mantle wall to reinforce the latter. The cone angle α of the mantle wall is equal to the cone angle of the conical surfaces 7 of the support rings 6a-6b.

1. A tubular screen for screening of pulp suspensions, comprising a mantle wall (1;24;31) provided with screen passages, and at least one support ring (6;6a,6b,6c), which surrounds the mantle wall and which is arranged to reinforce the mantle wall so that the latter is resistant to and is not deformed by dynamic forces during operation, characterized in that the support ring (6;6a,6b,6c) is designed with a conical surface (7), which abuts and presses directly or indirectly against the mantle wall (1;24;31).

2. A tubular screen according to claim 1, characterized in that the mantle wall (31) is conical with the same cone angle (α) as the conical surface (7) of the support ring (6;6a,6b,6c).

3. A tubular screen according to claim 1, characterized in that the mantle (24) forms an angular bulge (27), wherein the conical surface (7) of the support ring (6) presses against the bulge.

4. A tubular screen according to claim 3, characterized in that the annular bulge (27) is designed with a conical surface (30) which is complementary with a conical surface (7) of the support ring (6).

5. A tubular screen according to claim 3 or 4, characterized in that it is vertically oriented and that a conical surface (7) of the support ring (6) rests directly or indirectly on the annular bulge (27).

6. A tubular screen according to any one of claims 3-5, characterized in that it comprises a further support ring (6) with a conical surface (7), and that the mantle wall (24) forms a further annular bulge (27), wherein the conical surface of the further support ring presses against the further bulge.

7. A tubular screen according to claim 6, characterized in that the inner diameter of the further support ring (6) is larger than the outer diameter of the first mentioned bulge (27).

8. A tubular screen according to claim 1, characterized in that the mantle wall (24) is composed of a plurality of separate wall elements (25) distributed. in the circumference of the screen, wherein the support ring (6) subjects the wall segments to radially inwardly directed forces for secure fixing of the wall segments to one another.

9. A tubular screen according to claim 8, characterized in that each wall segment (25) has at least one external projection (26), wherein the conical surface (7) of the support ring (6) presses against the external projection.

10. A tubular screen according to claim 9, characterized in that each projection (26) is designed with a conical surface (30) which is complementary with the conical surface (7) of the support ring (6).

11. A tubular screen according to claim 9 or 10, characterized in that it is vertically oriented and that the conical surface (7) of the support ring (6) rests directly or indirectly on the projections (26) of the wall segments (25).

12. A tubular screen according to any one of claims 9-11, characterized in that the projections (26) of the wall segments (25) form an annular bulge (27) around the mantle wall (24), wherein the conical surface (7) of the support ring (6) presses against the bulge.

13. A tubular screen according to claim 12, characterized in that it comprises a-further support ring (6) with a conical surface (7), and that the projections (26) of the wall segments (25) form a further annular bulge (27), wherein the conical surface of the further support ring presses against the further bulge.

14. A tubular screen according to claim 13, characterized in that the inner diameter of the further support ring (6) is larger than the outer diameter of the first mentioned bulge (27).

15. A tubular screen according to claim 6 or 13, characterized in that the conical surface (7) of each support ring (6) presses indirectly against the bulge (27) associated to the support ring via an assemblage ring, which is arranged between the support ring and the bulge, wherein the assemblage ring is designed with a radially outer conical surface, which is complementary with the conical surface of the support ring and which abuts against the latter.

16. A tubular screen according to claim 15, characterized in that each assemblage ring is provided with a radially inner conical surface, which abuts against its bulge (27).

17. A tubular screen according to claim 15 or 16, characterized in that it is vertically oriented and that each support ring (6) rests on its assemblage ring.

18. A tubular screen according to claim 1, in which the mantle wall (1) comprises rod elements (2), which are distributed in the circumference of the screen spaced apart from one another so that the screen passages are formed between adjacent rod elements, and concentric fixing rings (3) surround the rod elements from the external side of the screen and fix the rod elements relative to one another, characterized in that the conical surface (7) of the support ring (6) abuts and presses directly or indirectly against any one of the fixing rings (3) to provide radially inwardly directed forces on the rod elements (2) via the fixing ring associated to the support ring.

19. A tubular screen according to claim 18, characterized in that the fixing ring (3) associated to the support ring (6) is designed with a conical surface which is complementary with the conical surface (7) of the support ring and which abuts against the latter.

20. A tubular screen according to claim 19, characterized in that it is vertically oriented and the support ring (6) rests on its associated fixing ring (3).

21. A tubular screen according to claim 18, characterized in that the conical surface (7) of the support ring (6) abuts indirectly against the fixing ring (3) associated to the support ring via an assemblage ring (13;16;20;22), which is arranged between the support ring and the fixing ring, wherein the assemblage ring is designed with a radially outer conical surface (14), which is complementary with the conical surface of the support ring and which abuts against the latter.

22. A tubular screen according to claim 21, characterized in that the assemblage ring (13;16;20) is provided with a radially inner conical surface (15) abutting against the fixing ring (3).

23. A tubular screen according to claim 21 or 22; characterized in that it is vertically oriented and that the support ring (6) rests on the assemblage ring (13).

24. A tubular screen according to any one of claims 15-17 and 21-23, characterized in that the assemblage ring (13;16;20;22) is slotted to enable radial expansion of it during assembling.

25. A tubular screen according to any one of claims 15-17 and 21-23, characterized in that each assemblage ring (13;16;20;22) is divided into at least two separate pieces.
